(19) United States
(12) Patent Application Publication
(10) Pub. No.: US 2017/0047178 A1
(43) Pub. Date: Feb. 16, 2017

(54) SPRING RING FOR AN INDEXED ROTARY SWITCH AND INDEXED ROTARY SWITCH

(71) Applicant: TRW AUTOMOTIVE ELECTRONICS AND COMPONENTS GMBH, Radolfzell (DE)

(72) Inventor: Erich Seeh, Neuhausen (DE)

(21) Appl. No.: 15/300,853

(22) PCT Filed: Apr. 28, 2015
(86) PCT No.: PCT/EP2015/059201

§ 371 Date: Sep. 30, 2016

(30) Foreign Application Priority Data
May 9, 2014 (DE) 10 2014 106 568.9

(51) Int. Cl. H01H 19/11; H01H 19/635; H01H 19/14

(52) U.S. Cl. CPC H01H 19/11; H01H 19/14; H01H 19/635; H01H 2221/01; H01H 2231/026

(57) ABSTRACT

A spring washer (26) for an indexed rotary switch (10) with a detent cam (20), in particular for a rotary push switch in a vehicle, has at least one indexing section (30) which includes a resiliency yielding projection (32) which is adapted to engage in a detent cam (20), and at least one contact section (40) which includes a contact surface (42) that can rest at the detent cam (20), the radius of curvature of the contact surface (42) being considerably larger than the radius of curvature of the projection (32). According to the invention, further provision is made for a rotary switch (10) having such a spring washer (26).

### RELATED APPLICATIONS

This application corresponds to PCT/EP2015/059201, filed Apr. 28, 2015, which claims the benefit of German Application No. 10 2014 106 588.9, filed May 9, 2014, the subject matter, of which are incorporated herein by reference in their entirety.

### BACKGROUND OF THE INVENTION

The invention relates to a spring washer for an indexed rotary switch having a detent cam, and to an indexed rotary switch.

Indexed rotary switches include a detent cam for a spring-mounted projection to engage therein. The increment of the indexing is predefined by the distance of the individual detent contours of the detent cam, between which the projection can engage. The projection is part of a spring washer, for example, which is arranged between the rotary member of the rotary switch and a base body and urges the rotary member away from the base body, the projection being urged against the detent cam. The spring force, for one thing, causes the projection to be urged into the detent cam or between the detent contours. For another thing, the entire rotary member is urged away from the base body and is thus held to be free of play. By way of supplement, a push-button switch may additionally be integrated by moving the rotary member against an electrical contact contrary to the spring force of the spring washer.

In the case of such rotary switches it is desirable, on the one hand, to adjust the general resistance when the rotary member is rotated. On the other hand, it is intended for the hardness of the increments, that is, the indexing, to be adjustable, so that white the individual detent steps are perceptible, there is no excessive resistance between the individual detent stages. In addition, it is intended for the resistance to a pushing in to be adjustable in a push-button switch. In the previously known spring washers, only the detent hardness can be adjusted. An additional fractional resistance, which provides for a better haptics of the rotary switch, can only be obtained by separate friction elements.

### SUMMARY OF THE INVENTION

It is the object of the invention to provide a rotary switch which allows an adjustability of the friction and of the detent hardness.

To achieve the object, provision is made for a spring washer for an indexed rotary switch having a detent cam, in particular for a rotary push switch in a vehicle, including at least one indexing section which includes a resiliently yielding projection which is adapted to engage in a detent cam, and at least one contact section which includes a contact surface that can rest at the detent cam, the radius of curvature of the contact surface being considerably larger than the radius of curvature of the projection. According to the invention, in addition to the indexing section by which the indexing of the rotary switch is provided in the known manner, a contact section is provided which can rest at the detent cam but can not engage into it. This means that the contact surface of the contact section is springily pressed against the detent cam, so that an increased friction is produced between the detent cam and the contact surface, the friction providing a resistance when the rotary member is rotated. To prevent the contact surface from engaging between the detent contours and therefore from also providing an indexing, the radius of curvature of the contact surface is considerably larger than that of the projection, the projection being curved such that it can engage between the detent contours, whereas the contact surface is configured such that it can not engage between the detent contours. In this context, “considerably larger” means that the radius of curvature of the contact section is larger than the radius of curvature of the indexing section at least by a factor of 3, preferably by a factor of 5 and particularly preferably by a factor of more than 10.

In a spring washer of this type it is conceivable that the contact surface and the projection are made to be springy. But a deformation of the contact surface may result in a change in the frictional properties. Also, a deformation of the projection may result in a change in the detent behavior. For this reason, it is desirable for the contact surface and the projection not to be subjected to any heavy deformations during regular operation. Therefore, provision is made that at least one of the indexing section and the contact section each have two spring sections provided thereon which are arranged in the peripheral direction of the spring washer in front of and behind the projection and the contact surface, respectively. These spring sections allow a limited movement of the contact surface and/or of the projection without their becoming deformed themselves. The thickness and/or the shape of these spring sections allow(s) the spring forces by which the contact surface and the projection are pressed against the detent cam to be adjusted separately, so that the frictional resistance and the indexing hardness can be adjusted separately from each other. A further advantage of the spring sections, which are arranged symmetrically in relation to the contact surface and the projection, resides in that the orientations of the contact surface and of the projection are not changed during deflection, so that their orientations in relation to the detent cam are not changed during deflection.

Different embodiments of the spring washer are possible, depending on the detent cam provided on the rotary switch. The contact surface and the projection may protrude in the radial direction, for example, if the detent cam is provided as an internal or external toothing on the rotary member or on the base body. But, preferably, the contact surface and the projection protrude in the axial direction with respect to the spring washer. In this embodiment, the rotary member is additionally acted upon in the axial direction, so that it is held free of play in the axial direction and a push function can be additionally implemented by moving the rotary member counter to the spring tension.

Preferably, the at least one indexing section and the at least one contact section are arranged uniformly distributed in the peripheral direction. The uniform distribution of the sections causes a uniform pressure on the rotary member in the axial direction, so that a jamming of the rotary member is prevented. More particularly, it is also conceivable for a plurality of indexing sections and contact sections to be provided, each alternately, that is, each indexing section being followed by a contact section.

The contact surface is preferably flat and extends substantially in the peripheral direction, so that it can rest flatly at the detent cam.

To prevent the contact surface from being able to engage in the detent cam, the length of the contact surface in the peripheral direction is, for example, greater than the distance between two detent contours of the detent cam.

To prevent the spring washer from rotating along with the detent cam, holding tabs are preferably provided on the spring washer for mounting the spring washer so as to prevent rotation, the holding tabs more particularly projecting in the opposite direction than the contact surface and the projection.

To achieve the object, further provision is made for an indexed rotary switch, in particular a rotary push switch in a vehicle, including a base body, a rotary member which is rotatable about a longitudinal axis and mounted at the base body for limited displacement in the direction of the longitudinal axis, the base body or the rotary member having provided thereon a detent cam with detent contours, and including a spring washer according to the invention, which is held on the rotary member or on the base body so as to prevent rotation and is pretensioned against the detent cam such that the at least one projection of the indexing section engages between two neighboring detent contours and the contact surface of the contact section rests on at least two neighboring detent contours of the detent cam and acts on the rotary member in the axial direction. Since the contact section having the contact surface does not engage into the detent cam, but merely rests on it, the contact surface merely provides a frictional resistance, but no increment or raster.

To prevent the contact surface from engaging in the detent cam, the length of the contact surface is preferably greater than the distance between two neighboring detent contours, more particularly twice as great as the distance between two neighboring detent contours.

The detent cam may, for example, be provided on the face side of the rotary member, and the detent contours protrude from the rotary member contrary to the axial direction in relation to the rotary member. In this embodiment, the contact surface and the projection protrude in the axial direction, so that they act upon the rotary member in the axial direction. As a result, the rotary member is held free of play and may additionally be made use of as a push switch.

### BRIEF DESCRIPTION OF THE DRAWINGS

Further advantages and features will be apparent from the description below in conjunction with the accompanying drawings, in which:

FIG. 1 shows a rotary switch from the prior art;

FIG. 2 shows the spring washer of the rotary switch of FIG. 1;

FIG. 3 shows a spring washer according to the invention;

FIG. 4 shows a first perspective view of a rotary switch according to the invention with the spring washer of FIG. 3;

FIG. 5 shows a side view of the rotary switch of FIG. 4;

FIG. 6 shows a second perspective view of the rotary switch of FIG. 4;

FIG. 7 shows a side view of the rotary switch of FIG. 6;

FIG. 8 shows a further view of the rotary switch of FIG. 4, with a housing being indicated; and

FIG. 9 shows a sectional view of the rotary switch of FIG. 4 in the area of the holding tabs of the spring washer.

### DESCRIPTION

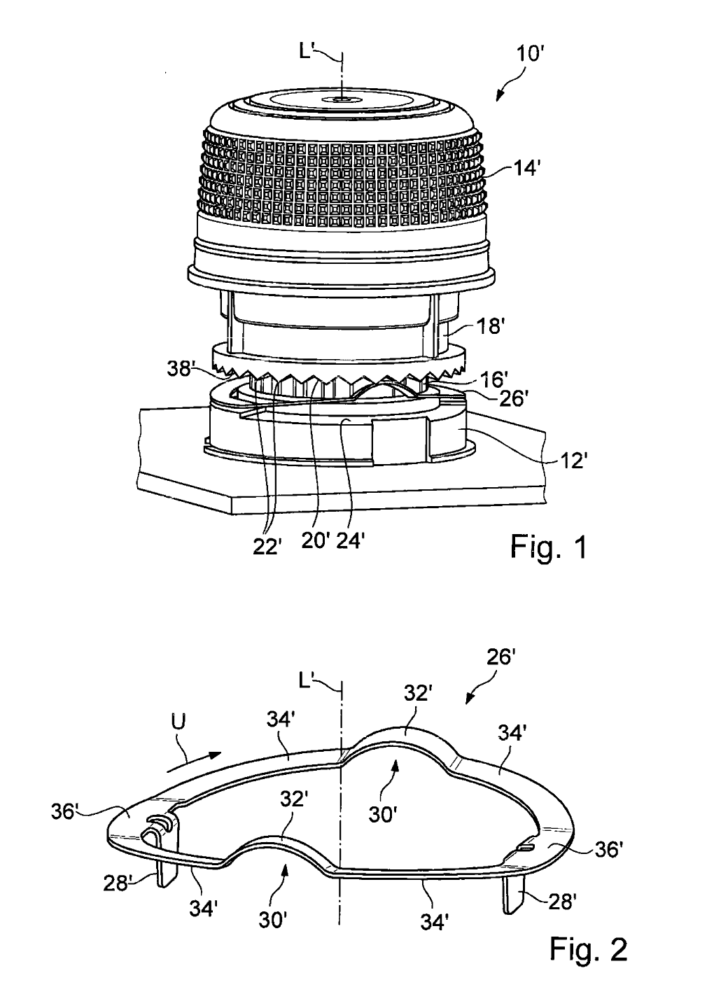

FIG. 1 shows a rotary switch 10′ from the prior art. The rotary switch 10′ has a base body 12′ which has a rotary member 14′ mounted thereon for rotation about a longitudinal axis L′ and for limited displacement in the direction of the longitudinal axis L′. The base body 12′ includes a protruding dome 16′ which extends into the interior of the rotary member 14′.

Provided on the lower front face, with respect to FIG. 1, of the rotary member 14′ is an indexing member 18′ which includes a detent cam 20′ protruding contrary to the longitudinal direction L′ and having a plurality of detent contours 22′. Further provided on the base body 12′ is a shoulder 24′ on which the spring washer 26′ rests which is shown in FIG. 2.

The spring washer 26′ is stamped out of a metal sheet and has a pair of protruding holding tabs 28′ bent at right angles contrary to the longitudinal direction L′ and engaging into slots on the shoulder 24′ so that the spring washer 26′ is mounted on the base body 12′ so as to prevent rotation in the peripheral direction U. The spring washer 26′ further includes a pair of indexing sections 30′ which each have a projection 32′ and spring sections 34′ that are arranged in front of and behind the projections 32′ in the peripheral direction U.

As can be seen in FIG. 1, the spring washer 26′ rests on the shoulder 24′ by a pair of holding sections 36′ which are located opposite each other in the peripheral direction and have the holding tabs 28′ provided thereon, and is held by the holding tabs 28′ so as to prevent rotation about the longitudinal axis L′ with respect to a direction of rotation.

The rotary member 14′ is placed with its detent cam 20′ on the base body 12′ such that the indexing sections 30′ are pretensioned in the longitudinal direction L′ between the shoulder 24′, that is, the base body 12′ and the detent cam 20′ of the rotary member 14′. This causes the projections 32′ to be urged against the detent cam 20′ or the detent contours 22′ and between the detent contours 22′.

Rotation of the rotary member 14′ is only possible when the projections 32′ are urged back by the detent contour 22′ contrary to the longitudinal direction L′. The projections subsequently snap into the next recess 38′ between the detent contours 22′.

In addition, the rotary switch 10′ may have a push function, so that an electrical contact is established by pushing in the rotary member 14′ contrary to the longitudinal direction L′.

The resistance to a pushing in of the rotary member 14′ may be increased, for example by increasing the spring tension of the spring sections 34′. But this also leads to an increased detent hardness of the indexing which is provided by the projections 32′ and the detent cam 20′. In addition, a separate adjustment of the resistance to rotation independently of the detent hardness is only possible if additional friction elements are provided between the base body 12′ and the rotary member 14′.

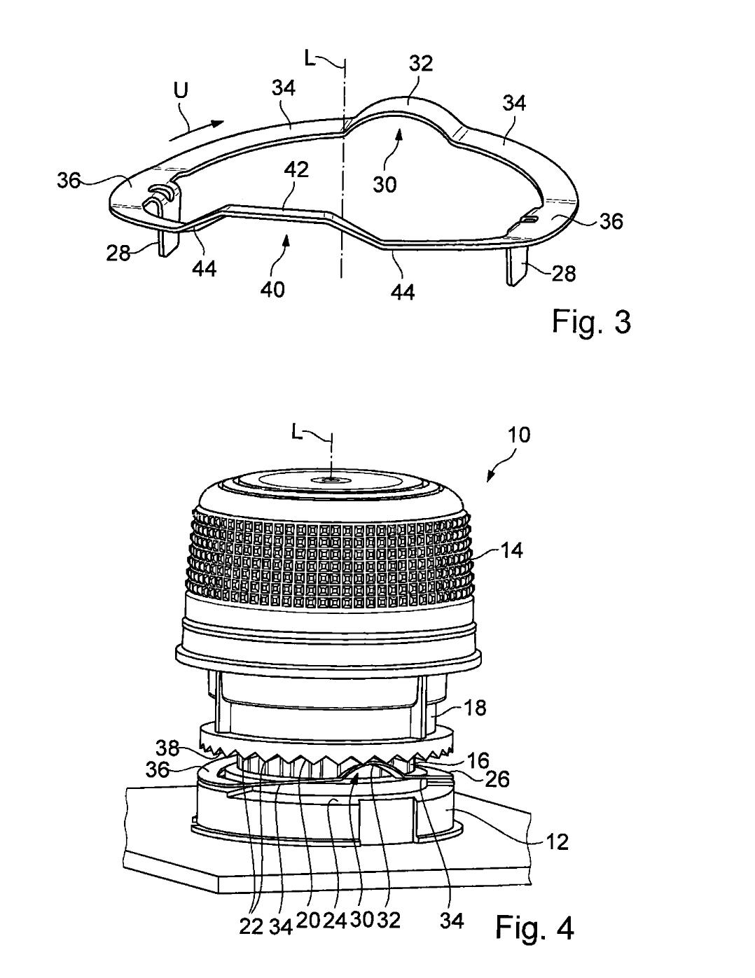

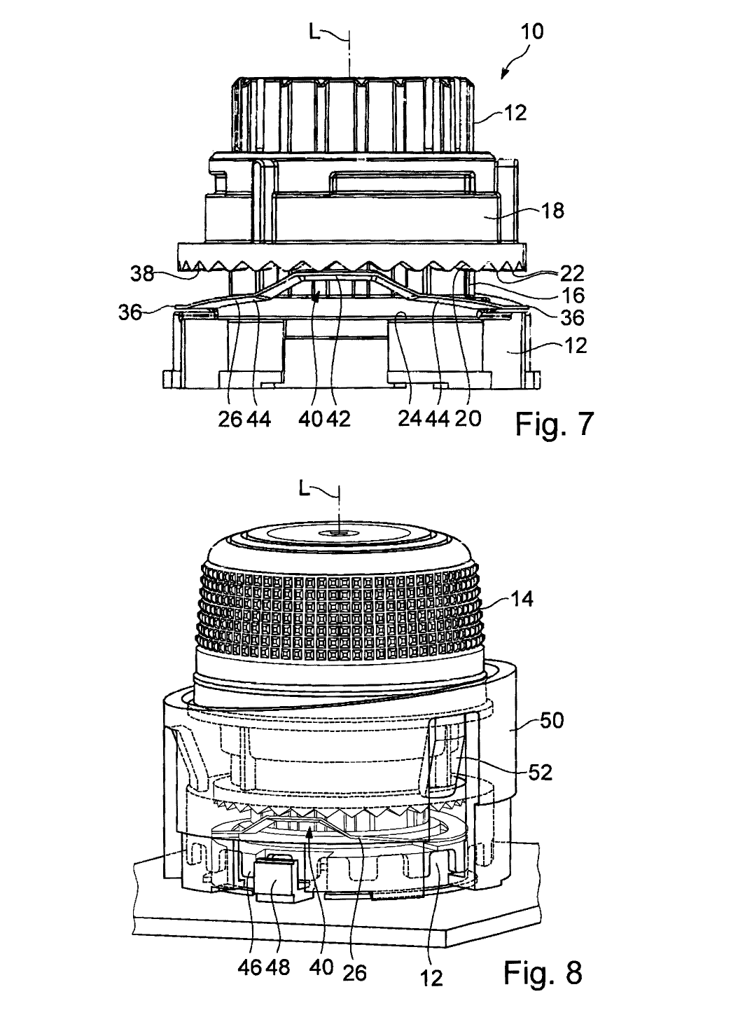

In order to overcome these problems, provision is made for the rotary switch 10 according to the invention, shown in FIGS. 4 to 7, and the spring washer 26 according to the invention, shown in FIG. 3. The rotary switch 10 essentially corresponds to the rotary switch 10′ shown in FIGS. 1 and 2. But, rather than the spring washer 26′ shown in FIG. 2, the spring washer 26 according to the invention, shown in FIG. 3, is used.

This spring washer 26 likewise has a pair of holding sections 36 located opposite each other and each including a holding tab 28 for mounting the spring washer 26 to the base body 12 so as to prevent rotation.

However, unlike the spring washer 26′ shown in FIG. 2, provision is made for only one indexing section 30 having a projection 32 and two spring sections 34 adjacent to the projection 32.

In place of the second indexing section, a contact section 40 is provided which has a contact surface 42 that is substantially flat in this embodiment and two spring sections 44 arranged in front of and behind the contact surface 42 in the peripheral direction U.

Thus, the contact surface 42 in a way replaces the second projection 32′ of the spring washer 26′ shown in FIG. 2.

As can be seen in FIG. 3, the projection 32 has a relatively small curvature, whereas the contact surface 42 has a very large curvature, which, in the embodiment shown here, goes to infinity, so that the contact surface 42 is configured to be approximately flat.

The spring washer 26 according to the invention is inserted between the base body 12 and the rotary member 14 in place of the conventional spring washer 26′ and attached to the base body 12 by means of the holding tabs 28.

In the inserted condition, the projection 32 or the indexing section 30 fulfils the same function as in the previously known rotary switches 10′, that is, the projection 32 engages between the detent contours 22 and in this way provides an indexing having a detent hardness that is defined by the spring sections 34.

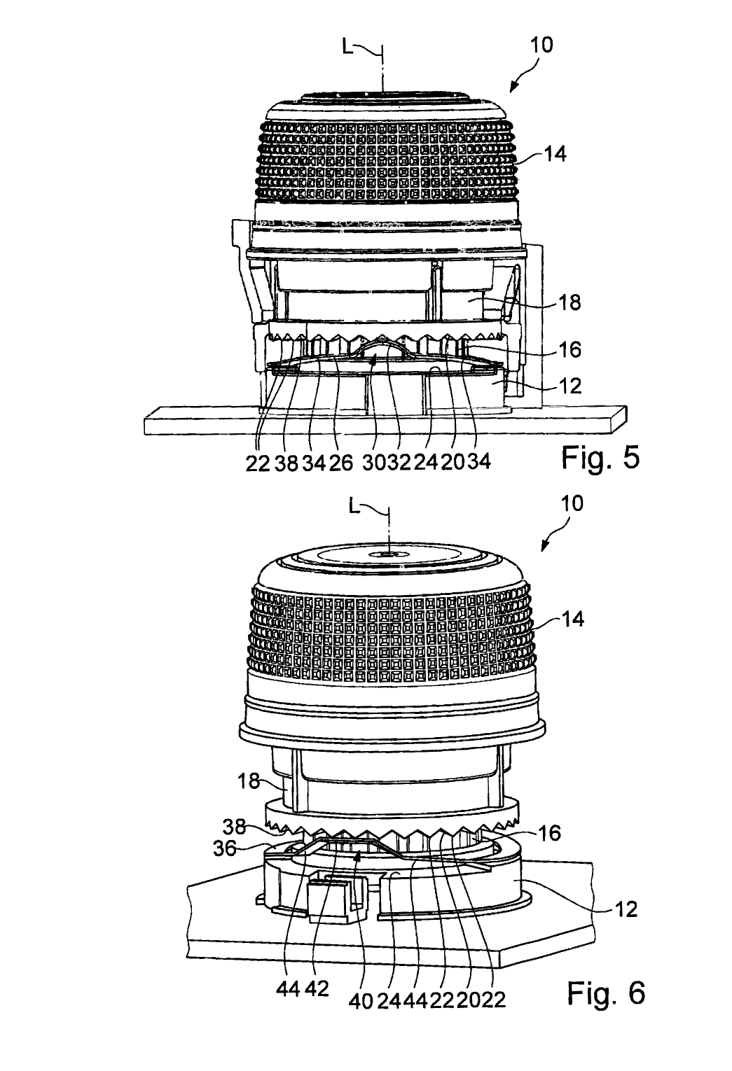

As can be seen in FIGS. 4 and 5, due to its considerably larger curvature, the contact surface 42, by contrast, can not engage between the detent contours 22, but only rests on the detent cam 20, that is, on the detent contours 22.

Thus, while the spring sections 44 provide a spring force in the longitudinal direction L, no additional force is provided for indexing the rotary member 14 since the contact surface 42 can not engage between the detent contours 22.

As a result, the contact surface 42 generally increases the frictional resistance in the direction of rotation of the rotary member 14 without changing the characteristic of the indexing by the projection 32 and the detent cam 20.

Accordingly, the spring washer 26 has a double function: For one thing, the spring washer 26, as known from the prior art, provides for the indexing of the rotary switch 10 or of the rotary member 14. For another thing, the spring washer 26 generally increases the friction between the rotary member 14 and the base body 12 or provides for a spring force in the longitudinal direction L, which, firstly, allows the haptics of the rotary switch 10 to be adjusted and, secondly, allows a mounting free of play of the rotary member 14, without a change in the characteristic of the indexing.

The contact surface 42 and the contact section 40 may have any desired configuration here, as long as it is made sure that the contact surface 42 can rest at the detent cam 20, but can not engage between the detent contours 22. In order to prevent this, the contact surface 42 is made flat, for example, with the length of the contact surface 42 in the peripheral direction U being preferably greater than the distance between two detent contours 22.

In conjunction with the symmetrically arranged spring sections 44, the illustrated embodiment with a flat contact surface 42 additionally has the advantage that the contact surface 42 is urged across its entire area against the tips of the detent contours 22, so that a uniform friction can be generated.

FIG. 8 shows a further view of the rotary switch 10 according to the invention. As a supplement, a code wheel 46 provided on the lower face side of the indexing member 18 and having a reading unit 48 on the base body side is illustrated here as well as an outer cylindrical housing part 60 of the rotary switch 10. The housing part 50 has a plurality of detent tabs 52 provided thereon for the rotary member 14 or the indexing member 18 to snap in place.

Unlike in the embodiments shown, however, the spring washer 26 may also be held on the rotary member 14, and the detent cam 20 is provided on the base body 12.

It is also conceivable that the projection 32 and the contact surface 42 are made to be springy in the radial direction and the detent cam is formed as an internal or external toothing on the rotary member 14 or on the base body 12.

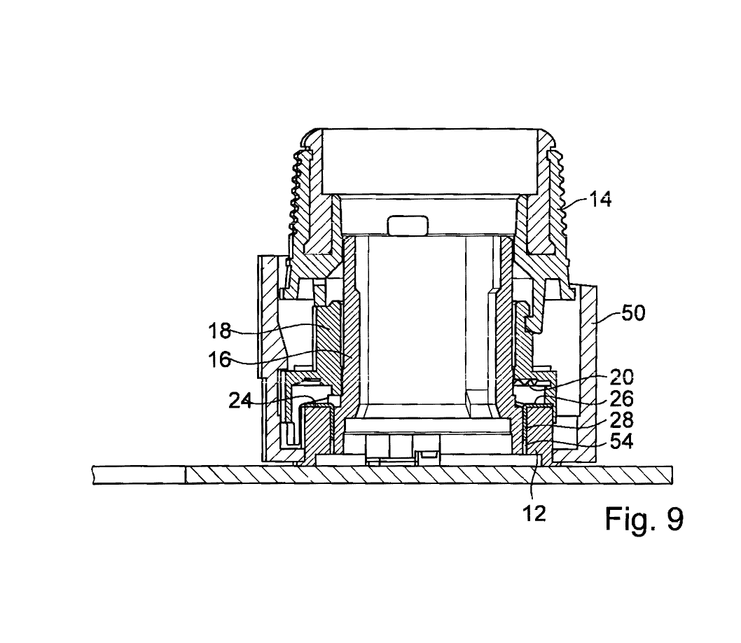

FIG. 9 shows a sectional view of the rotary switch 10 in the region of the holding tabs 28 of the spring washer. The holding tabs engage into slots 54 on the base body 14, so that the spring washer is held so as to prevent rotation in the peripheral direction U.

1. A spring washer (26) for an indexed rotary switch (10) having a detent cam (20), in particular for a rotary push switch in a vehicle, comprising at least one indexing section (30) which includes a resiliency yielding projection (32) which is adapted to engage in a detent cam (20), and at least one contact section (40) which includes a contact surface (42) that can rest at the detent cam (20), the radius of curvature of the contact surface (42) being considerably larger than the radius of curvature of the projection (32).

2. The spring washer according to claim 1, wherein at least one of the indexing section (30) and the contact section (40) each includes two spring sections (34, 44) which are arranged in the peripheral direction in front of and behind the projection (32) and the contact surface (42), respectively.

3. The spring washer according to claim 1, wherein the contact surface (42) and the projection (32) protrude in the axial direction with respect to the spring washer (26).

4. The spring washer according to claim 1, wherein at least one indexing section (30) and the at feast one contact section (40) are arranged uniformly distributed in the peripheral direction (U), more particularly each indexing section (30) being followed by a contact section (40) in the peripheral direction (U).

5. The spring washer according to claim 1, wherein the contact surface (42) is flat and extends substantially in the peripheral direction (U).

6. The spring washer according to claim 1, wherein the length of the contact surface (42) in the peripheral direction (U) is greater than the distance between two detent contours (22) of the detent cam (20).

7. The spring washer according to claim 1, wherein holding tabs (28) are provided on the spring washer (26) for mounting the spring washer (26) so as to prevent rotation, the holding tabs (28) more particularly projecting in the opposite direction than the contact surface (42) and the projection (32).

8. An indexed rotary switch (10), in particular a rotary push switch in a vehicle, comprising a base body (12), a rotary member (14) which is rotatable about a longitudinal axis (L) and mounted at the base body (12) for limited displacement in the direction of the longitudinal axis (L), the base body (12) and the rotary member (14) having provided thereon a detent cam (20) with detent contours (22), and comprising a spring washer (26) according to claim 1, which is held on the rotary member (14) or on the base body (12) so as to prevent rotation and is pretensioned against the detent cam (20) such that the at least one projection (32) of the indexing section (30) engages between two neighboring detent contours (22) and the contact surface (42) of the contact section (40) rests on at least two neighboring detent contours (22) of the detent cam (20) and acts on the rotary member (14) in the axial direction.

9. The rotary switch according to claim 8, wherein the length of the contact surface (42) in the peripheral direction (U) is greater than the distance between two neighboring detent contours (22), more particularly twice as great as the distance between two neighboring detent contours (22).

10. The rotary switch according to claim 8, wherein the detent cam (20) is provided on a face side of the rotary member (14) and the detent contours (22) protrude from the rotary member (14) contrary to the axial direction in relation to the rotary member (14), and in that the contact surface (42) and the projection (32) protrude in the axial direction.
